(19) United States
(12) Patent Application Publication
(10) Pub. No.: US 2012/0000333 A1
(43) Pub. Date: Jan. 5, 2012

(54) ROTARY CUTTING MACHINE

(75) Inventors: Kenneth HATCHER, Smyrna, TN (US); Rosemary SHIMP, Nolensville, TN (US); David SASUR, Ludlow, MA (US)

(73) Assignee: SIMPLICITY PATTERN CO. INC., Antioch, TN (US)

(21) Appl. No.: 13/117,650

(22) Filed: May 27, 2011

Related U.S. Application Data
(60) Provisional application No. 61/348,797, filed on May 27, 2010.

(51) Int. Cl. B26D 9/00; B26D 3/00; B26D 7/32; B26D 1/36; B26D 1/40

(52) U.S. Cl. 83/52; 83/343; 83/301; 83/311; 83/13

(57) ABSTRACT

A rotary cutting device includes a body having a cutter blade with a cutting edge and a pressure roller mounted relative to the cutter blade. The cutter blade is configured to rotate about a rotational axis. The pressure roller is rotationally fixed. The cutter blade and the pressure roller are positioned relative to each other such that pressure is applied to a material fed therebetween. As the cutter blade rotates relative to the pressure roller, the pressure applied to the material being fed therebetween allows for a width of material to cut by a cutting edge of rotating cutter blade. An embossing roller may be used in place of the cutter blade to emboss material. The device also includes guide for guiding material into the machine, pressure adjustment for pressure applied to the material, and rotational speed control. A method for using the rotary cutting device is also disclosed.

### BACKGROUND

1. Field

The present disclosure relates to a rotary cutting device for cutting or embossing a material, and more particularly to a rotary cutting machine that uses pressure between a roller and another device to cut or emboss a material.

2. Description of Related Art

Various crafts and sewing work requires strips of fabric or paper for decorating and embellishing, for example, scrapbook pages and garments. Quilters use cut strips of fabric for piecing. Rug hookers also use cut strips of fabric for hooking rugs.

Material strips are typically cut by scissors or sharp rotary blades. These methods of strip cutting may have difficulty in producing lengths of material having consistent width and can be quite time consuming.

Industrial pinking machines such as those disclosed in U.S. Pat. Nos. 1,984,224; 2,159,716; 2,240,996; and 2,520,529 can be used to pink edges of fabric and generally use sharp rotary blades and pressure to produce the cutting effect. These devices can have issues including the sharpness of the blade, the inability of the user to easily cut strips of material having the same width, and complex and numerous parts to adjust the pressure between the blade and material.

The inventors have recognized a need for a rotary cutting machine that can be adjusted to easily and safely cut strips of various types of material having an equal width along the entire length thereof.

### SUMMARY

One aspect of the disclosure provides a rotary cutting device. The rotary cutting device includes a body having a motor therein that is configured to selectively receive power from a power source, a cutter blade with a cutting edge mounted to a shaft in the body, and a pressure roller mounted relative to the cutter blade on a bearing shaft. The shaft for the cutter blade is configured to rotate about a rotational axis. The pressure roller is fixed to remain rotationally stationary relative to the bearing shaft and to the cutter blade. The cutter blade and the pressure roller are positioned relative to each other such that pressure is applied to a material fed therebetween. The motor is configured to selectively rotate the shaft about its axis upon receipt of power from the power source such that the cutter blade rotates relative to the pressure roller so that a width of material is cut by the cutting edge as the material is fed between the rotating cutter blade and the pressure roller

Another aspect of the disclosure provides another rotary cutting device. The rotary cutting device includes a body having a motor therein that is configured to selectively receive power from a power source, an embossing roller with an embossing edge mounted to a shaft in the body, and a pressure roller mounted relative to the embossing roller on a bearing shaft. The shaft for the embossing roller is configured to rotate about a rotational axis. The pressure roller is fixed to remain rotationally stationary relative to the bearing shaft and to the embossing roller. The embossing roller and the pressure roller are positioned relative to each other such that pressure is applied to a material fed therebetween. The motor is configured to selectively rotate the shaft about its axis upon receipt of power from the power source such that the embossing roller rotates relative to the pressure roller so that a width of material is embossed using the embossing edge as the material is fed between the rotating embossing roller and the pressure roller.

Yet another aspect of the disclosure includes a method for cutting material using a rotary cutting device that has a body having a motor therein that is configured to selectively receive power from a power source, a cutter blade with a cutting edge mounted to a shaft in the body, the shaft configured to rotate about a rotational axis, a pressure roller mounted relative to the cutter blade on a bearing shaft, the pressure roller being fixed to remain rotationally stationary relative to the bearing shaft and to the cutter blade, the cutter blade and the pressure roller being positioned relative to each other such that pressure is applied to a material fed therebetween, and the motor being configured to selectively rotate the shaft about its axis such that the cutter blade rotates relative to the pressure roller so that a width of material is cut by the cutting edge as the material is fed between the rotating cutter blade and the pressure roller. The method includes: providing the rotary cutting device; providing power to the motor from the power source; rotating the shaft about its axis so that the cutter blade rotates relative to the pressure roller; inserting the material into the machine and between the cutter blade and the pressure roller, and cutting the material using pressure from the cutter blade and the pressure roller.

These and other features, aspects, and advantages of the present disclosure will become apparent from the following detailed description of the preferred embodiments relative to the accompanied drawings, and the appended claims.

### BRIEF DESCRIPTION OF THE DRAWINGS

FIG. 1 is a perspective view of an embodiment of a rotary cutting device of the present disclosure.

FIG. 2 is a front view of the rotary cutting device of FIG. 1.

FIG. 3 is a top view of the rotary cutting device of FIG. 1.

FIG. 4 is a front view of the cutting blade assembly and screw lock assembly of the rotary cutting device of FIG. 1.

FIG. 5 is a side perspective view of the cutting blade assembly, drive mechanism and screw lock assembly of the rotary cutting device of FIG. 1.

FIG. 6 is a perspective view of the pressure roller bearing shaft.

FIG. 7(A)-7(G) illustrate the plurality of rotary cutter blades of the present disclosure.

FIG. 8 is a perspective view of another embodiment of a rotary cutting device of the present disclosure.

FIG. 9 is an exploded view of the rotary cutting device of FIG. 8.

FIG. 10 is a side view of the rotary cutting device of FIG. 8.

FIG. 11 is a front view of the rotary cutting device of FIG. 8.

FIG. 12 illustrates diagrams illustrating a method for changing a cutter blade for an alternate cutter blade and using in the rotary cutting device of FIG. 1.

FIG. 13 illustrates diagrams related to the rotary cutting device of FIG. 8.

### DETAILED DESCRIPTION

The rotary cutting device of the present disclosure is designed to cut a variety of different materials including, but not limited to, cotton, silk, satin, felt, wool, paper, and canvas. As will be described further herein, the cutting of the material is accomplished by the pressure between a pressure roller and cutter blade. The device can use interchangeable blades, each having a different cutting edge. The rotary cutting device of the present disclosure can cut strips of material, ranging in a number of widths. The device can be used to trim edges of a material. Moreover, in an embodiment, instead of cutting strips, the device may be fit with an embossing roller to emboss a pattern onto a material. The rotary cutting device may be used to cut and/or emboss materials used for any type of project including crafting, sewing, quilting, scrapbooking, rug hooking, and locker hooking projects, for example.

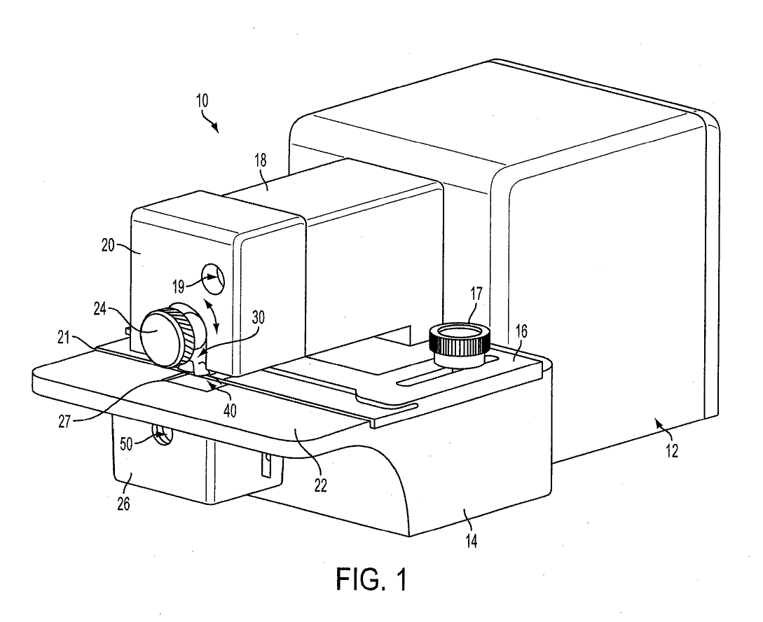

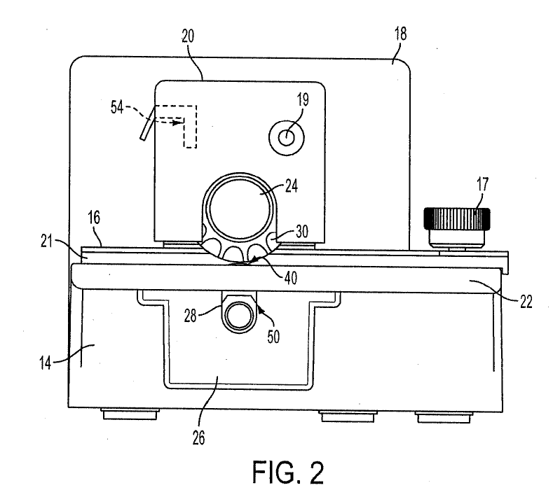

Referring to FIGS. 1 and 2, a first embodiment of a rotary cutting device 10 of the present disclosure includes a body comprising motor housing 12, base 14 and cutter housing 18. The rotary cutting device 10 is configured such that material may be positioned on the base 14 and fed to cutter blade 30 of cutter housing 18 for cutting. As will be further understood in the detailed description below, motor housing 12 is configured to house a drive mechanism 34, motor 36, and other components for supplying power to the rotary cutting device 10. Base 14 is used for positioning the device 10 on a surface (e.g., table) and for guiding material relative to the cutting blade assembly of the cutter housing 18. The cutter housing 18 includes mechanism(s) for mounting parts of the cutting blade assembly and for transferring power from the motor housing 12 to the cutting blade assembly, so that a user can cut strips or widths of material.

A cutter guard 20 is removably attached to cutter housing 18 by a fastener. In the illustrated embodiment, a screw 19 is configured to act as the fastener. Screw 19 is aligned and positioned through holes in the cutter guard 20 and side of the cutter housing 18 so that when screw is tightened the guard 20 and housing 18 are attached to each other. The cutter guard 20 acts a safety device that reduces and/or prevents direct access to a cutter blade 30 by covering the blade 30. Removal of screw 19 allows for removal of cutter guard 20 and thus enables the user to access blade 30. In an embodiment, a safety switch 54 is disposed within cutter guard 20 (see FIG. 2), so that if/when guard 20 is removed from cutter housing 18, switch 54 is activated to prevent the motor from rotating shaft 32 and hence blade 30. Cutter housing 18 is open at a bottom end to enable a portion of cutter blade 30 to extend outwardly therefrom. Cutter guard 20 can be made of a clear material, such as a molded plastic, to enable the user to see the cutter blade 30 (e.g., so that a type or edge of cutter blade 30 may be easily viewed).

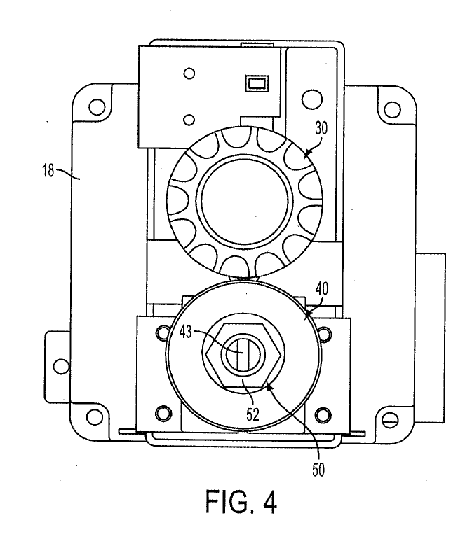

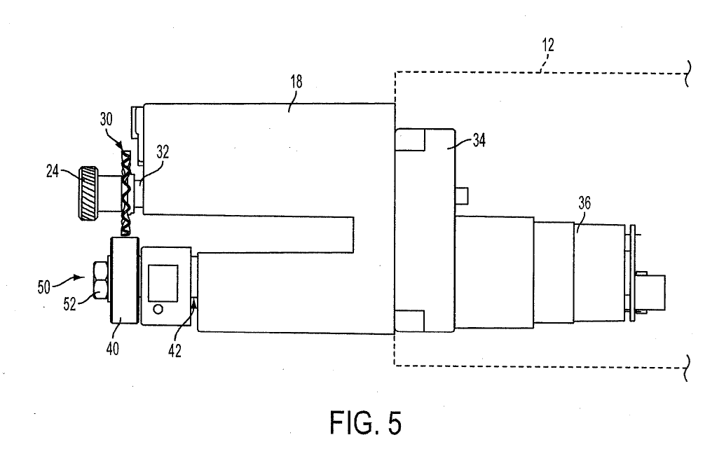

Cutter blade 30 is a blade with a cutting edge that is designed to cut material(s) using pressure. The blade can be round or circular with the cutting edge around its periphery. Cutter blade 30 is configured to be positioned and rotated relative to pressure roller 40, by mounting to a shaft 32 in the body, as will become evident by the description. Edges of cutter blade 30 are designed such that the blade 30 can be held by a user without risk of cutting. Cutter blade 30 is mounted relative to cutter housing a knob 24. Knob 24 holds the cutter blade 30 in place and can be tightened or loosened by rotating the knob 24 (e.g., clockwise or counterclockwise). Further details regarding mounting of cutter blade 30 are described below with respect to FIGS. 4 and 5.

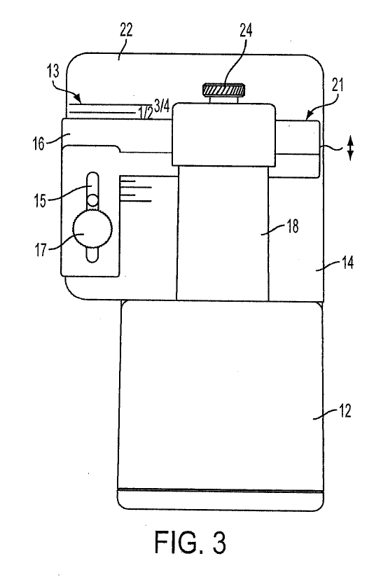

As shown in FIG. 3, base 14 includes a cutter plate portion 22. A material guide 16 is movably mounted on base 14 in communication with cutter plate portion 22. Guide 16 is provided to guide material into the rotary cutting device for cutting relative to cutter blade 30 and to select a width at which material is cut. Guide 16 is positioned so that a longitudinal edge 21 thereof is positioned relative to (e.g., adjacent to) blade 30. Guide 16 includes a slot 15 through which a guide knob 17 extends. Guide knob 17 may be tightened or loosened so that slot 15 can allow guide 16 to slide relative to knob 17 and the longitudinal edge 21 of the guide 16 can be positioned (relative to the blade) at the desired width. Knob 17 is tightened when the longitudinal edge 21 of guide 16 is in position at a desired location. Indicia 13 is printed on cutter plate 22 and/or base 14 to aid in positioning guide 16 and cutting the desired width of material strip. For example, longitudinal edge 21 of the guide 16 may be aligned with an area or marking (e.g., line) of the indicia 13. In an embodiment, the width of the strip of material to be cut may be in a range of approximately ⅜ inches to approximately 2 inches. However, this range is not meant to be limiting.

Referring again to FIG. 2, a pressure roller housing 26 is located below cutter plate 22. Pressure roller housing 26 is mounted to base 14. A pressure roller 40 is located within roller housing 26. Roller housing 26 also includes an aperture 28 through which the user can access a screw lock assembly 50, shown in greater detail in FIG. 4. Pressure roller 40 is configured to extend through roller housing 26. For example, as better shown in FIG. 1, cutter plate portion 22 includes an opening 27 for a portion of roller 40 to extend upwardly therethrough and to communicate with an edge of cutter blade 30.

FIGS. 4 and 5 show a simplified design of an end of rotary cutting device 10 without base 14, guide 16, cutter guard 20, and cutter plate 22, so that parts of the cutting blade assembly and screw lock assembly 50 can be readily viewed. As shown, a pressure roller 40 and a cutter blade 30 are arranged to be relatively spaced (with respect to each other) such that a length of material can be received therebetween for cutting. Cutter blade 30 is configured to be mounted on a shaft 32 using knob 24 (e.g., knob 24 locks cutter blade 30 onto shaft 32 so that the blade 30 will rotate with the shaft 32, not relative thereto). Shaft 32 is mounted in the housing and is attached to a drive mechanism 34. Drive mechanism 34 includes a motor 36, such as an electrically powered motor, and a plurality of gears (not shown). Drive mechanism 34 and motor 36 are located within motor housing 12, and are configured to selectively receive power from a power source (e.g., via a plug device) and to rotate shaft 32 upon receipt of power (e.g., via a foot pedal). Drive mechanism 34 may have any number of motors and may include one or more transmissions (not shown). Motor 36 may be an AC induction motor or a DC motor. Motor 36 operates using electrical power to rotatably drive shaft 32 so that a mounted cutter blade 30 is rotated relative to a pressure roller 40.

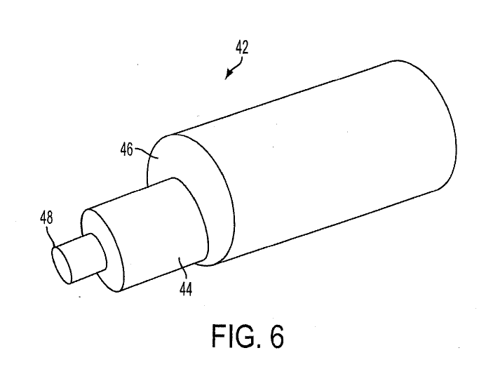

Pressure roller 40 is configured to provide pressure to material toward cutter blade 30 (i.e., in an upward direction) so that material is cut as it is fed through the device 10. Pressure roller 40 is mounted to the device 10 and positioned relative to cutter blade 30 using screw lock assembly 50. Screw lock assembly 50 comprises a bearing shaft 42 with a screw 43 and a bearing 52 disposed thereon. Pressure roller 40 is mounted on bearing shaft 42 that extends through pressure roller housing 26 and may be mounted therein (or it may be mounted relative to base 14). Bearing shaft 42 is configured to rotate about an axis. As shown in FIG. 6, bearing shaft 42 includes an end element 46, a middle portion 44, and an end 48. Middle portion 44 is of a reduced width as compared to end element 46, and is configured to be offset from a center of the end element 46. Middle portion 44 is sized such that the pressure roller 40 can be received or mounted thereon (e.g., an inner diameter of pressure roller fits over an outer diameter of middle portion 44). The pressure roller 44 may be friction-fit or secured to the middle portion 44 of bearing shaft 42 using a securement or fastening device. For example, in the illustrated embodiment, end 48 of bearing shaft 42 is threaded to receive a bearing 52. After pressure roller 40 is mounted on middle portion 44 of bearing shaft 42, bearing 52 is screwed on the end 48 (e.g., with a washer) to assist in holding pressure roller 40 on the shaft 42. Pressure roller 40 is fixed to remain rotationally stationary relative to the bearing shaft 42 and to the cutter blade 30.

The screw 43 (e.g., a tap head screw) is located in end 48 and accessible through bearing 52. A user can insert a tool such as a screw driver into a head of the screw 43 to rotate the same. The screw 43 is fixed from rotation relative to the bearing shaft 42 such that rotation of the screw 43 will correspondingly rotate the bearing shaft 42. The offset of middle portion 44 is therefore rotated as the screw 43/shaft 42 is rotated. This offset results in converting the rotation into a vertical translation of a surface of the pressure roller 40 upward or downward such that a greater or lesser portion of its outer surface extends through opening 27 on cutter plate portion 22. As noted above, pressure roller 40 is adapted to be adjusted relative to the cutter blade 30 (i.e., vertically in an upward or vertical direction, when the device 10 is positioned on a surface). For example, when screw 43 is rotated and thus bearing shaft 42 is rotated about its axis, pressure roller 40 is moved in an upward direction or downward direction in relation to blade 30, thus adjusting a pressure to be applied to a material positioned between the pressure roller 40 and blade 30 and enabling cutting of the material. As will be appreciated, the adjustment may also be used for accommodating materials of differing thicknesses. Rotation of the screw 43 can adjust the amount of pressure applied to a material being cut, as an outer surface of pressure roller 40 can be moved closer to (for greater pressure between the blade 30 and roller 40) or farther from (for lesser pressure therebetween) the cutting edge of cutter blade 30. In one embodiment, screw 43 can be turned in increments (e.g., in increments of ⅛ inches) so that a user can incrementally test the pressure for cutting the material. Screw 43 may be moved in a first direction (to the left, or counterclockwise) to move pressure roller 40 in a downwardly vertical direction relative to cutter blade 30, and a second direction (opposite, i.e., to the right, or clockwise) to move the roller 40 in an upwardly vertical direction relative to the cutter blade 30, or vice versa.

Of course, it should also be understood that devices other than a screw 43 may be provided on bearing shaft 42 for rotation thereof.

In an embodiment, as a user rotates bearing shaft 42 (using screw 43 or another device), a tactile, and possibly an audio (e.g., a clicking noise), feedback may be provided as the bearing shaft 42 moves (rotates) relative to/within roller pressure housing 26. Thus, the user will actually be able to feel and/or hear the plurality of predefined positions for positioning the pressure roller as the screw 43/bearing shaft 42 is moved. This provides the user with a quick and easy way to incrementally change the spacing between the cutter roller 30 and pressure roller 40 surfaces, and thus the pressure applied to the material.

In an embodiment, the rotary cutting device 10 comes with two or more blades that may be interchanged for one another using cutter housing 18. For example, one blade may be inserted or installed in the device (e.g., before packaging) so that the device or machine is ready for use, while another is selectively used. In an embodiment, each cutter blade can include a hole for alignment with a notch on the device for accurate installation on the shaft 32. That is, each cutter blade may include a first (larger) hole for mounting on the shaft 32, and a second (smaller) hole for alignment with a notch on the cutter housing 18. In an embodiment, if the cutter blade is not aligned properly on the cutter housing 18 (i.e., with its notch), it will not rotate the blade for cutting.

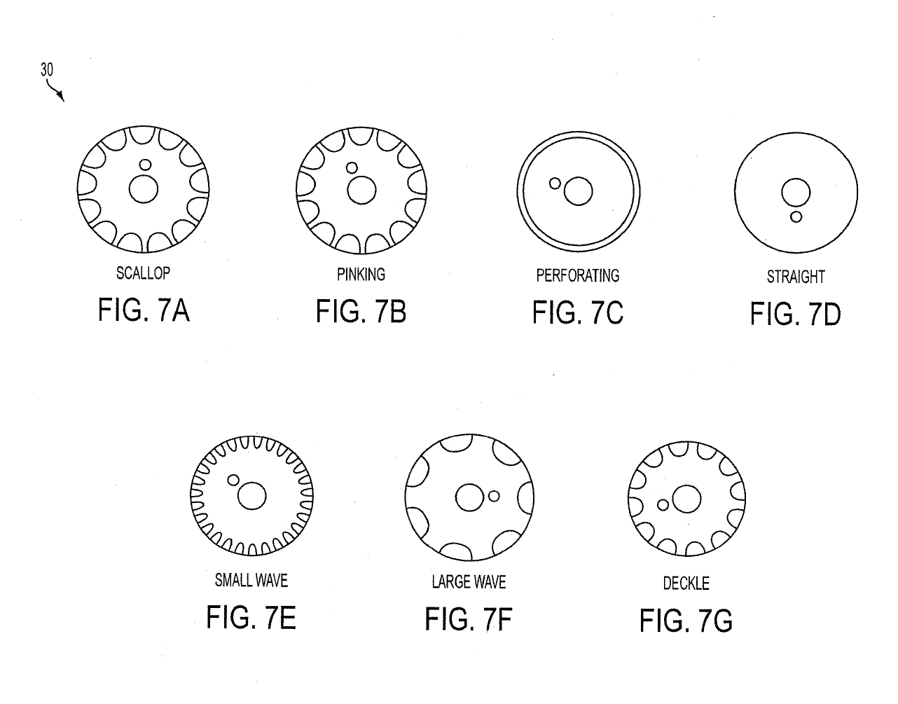

A variety of different edged blades can be used with the rotary cutter device 10 of the present disclosure. As shown in FIGS. 7(A)-7(G), edges of the cutter blades 30 can vary and be interchanged with one another. One or more second cutter blades with different cutting edges may be provided with the device 10 or provided (e.g., sold) separately. For example, the blade for cutting may include a scallop design (FIG. 7(A)), a pinking design (FIG. 7(B)), a perforating design (FIG. 7(C)), a straight edge design (FIG. 7(D)), a smaller wave design (FIG. 7(E)), a larger wave design (FIG. 7(F)), or a deckle design (FIG. 7(G)). It should be appreciated, however, that a variety of different blades can be used with rotary cutter device 10, depending on the user's desired cut or edge finish.

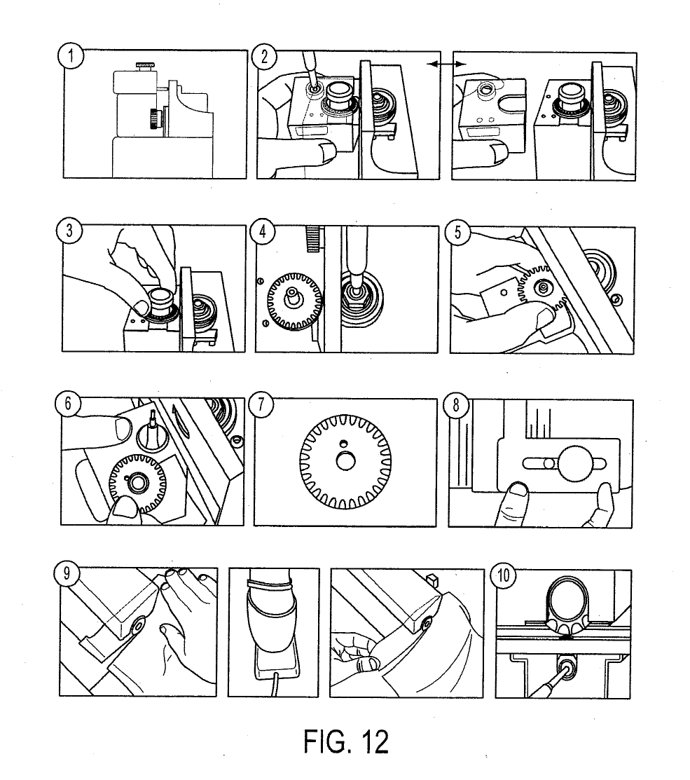

FIG. 12 illustrates diagrams illustrating a method for changing a cutter blade for an alternate cutter blade and using in the rotary cutting device 10 of FIG. 1. To remove or change the cutter blade 30, the device 10 is positioned so that the mounted blade 30 and bearing 52 of pressure roller 40 are accessible (e.g., the machine can be turned on its side, with the blade 30 and roller 40 facing upwardly). The screw 19 of cutter guard 20 is unscrewed with a tool (e.g., screw driver) so that the guard 20 is unattached from the cutter housing 18. The cutter guard 20 is removed (e.g., sliding a direction away from cutter housing 18) and set aside.

Knob 24 is rotated for loosening and removal from connection with shaft 32 (e.g., in a counterclockwise direction). This allows for removal of the mounted cutter blade 30. Once removed, knob 24 is set aside.

It should be appreciated that in order to remove the mounted cutter blade 30, the pressure between the blade 30 and pressure roller 40 may need to be loosened. Thus, the screw lock assembly 50 can be loosened via turning the bearing 52 and turning the screw 43 using a tool (e.g., screwdriver) at the end 48 of the bearing shaft 42 (e.g., turning in a counterclockwise direction), to move the pressure roller 40 in an opposite direction relative to (i.e., away from) the mounted cutter blade 30. The blade 30 is then removed from the shaft 32 and device 10.

Assuming the cutter blade 30 for mounting has two holes as noted above (i.e., a first (larger) hole and a second (smaller) hole for mounting on shaft and aligning with a notch, respectively), the cutter blade is positioned and aligned on the device 10 so that the second (smaller) hole aligns with the notch. The cutter guard 20 may then be aligned relative to the cutter housing 18 and mounted in place by tightening screw 19 in place. The screw 42 and bearing 52 for the pressure roller 40 are also tightened. The rotary cutting device 10 is then ready for use with the newly mounted cutter blade 30.

Once the proper blade has been installed and the user is ready to cut, the device can be plugged into a polarized electrical outlet or wall socket. Although not shown, the device 10 is provided with an electric supply cord and polarized plug configured for insertion into such an outlet to receive power thereto. For example, the device may be designed for universal electronic sources and be UL approved for the United States and/or Australia. The plug and its cord may be attached directly to, or removably attached to, the device (e.g., attached to or inserted into an area on the back of the device). For example, the cord may have a connection device at one end for connection to the device and a plug at its other end for connection to the outlet. In an embodiment, a foot pedal (also not shown) attaches to the device. The foot pedal may be configured to connect to the device via an electrical cord at one end, with the other end connection to an electrical outlet, so that power can be delivered to the rotary cutting device via pressure applied to the foot pedal. A foot pedal allows a user to selectively enable the operation of the rotary cutting device 10. The user presses the foot pedal to drive motor 36 and rotate blade 30.

In an embodiment, it is envisioned that the rotary cutting device may receive power from batteries supplied in a battery compartment (not shown). The battery compartment may be provided as an alternative to or in addition to an electrical cord with a plug.

To use the rotary cutter device 10, a user first determines a width of a strip of material to be cut. The longitudinal edge 21 of the guide 16 is adjusted by rotating the knob 17 (e.g., loosening in a counterclockwise direction) and sliding the guide 16 relative to the knob 17 using slot 15. Once the longitudinal edge of the guide 16 is provided at a desired width (e.g., by aligning with a selected length as indicated by indicia 13), knob 17 is tightened to secure guide 16 (e.g., in an opposite direction for loosening, e.g., in a clockwise direction).

Then, an edge of material is positioned against longitudinal edge 21 of the guide 16, and the foot pedal is pressed to supply power to the device 10 and to begin cutting (e.g., by guiding and pulling material along the guide 16). The lead edge of the fabric should be behind the blade when beginning to cut.

If the user determines that the cutter blade 30 does not cut the material as desired, the user can adjust the pressure between the blade 30 and the pressure roller 40. Pressure to the foot pedal (not shown) is released, and the power to the device 10 turned off. Screw 43 can be turned in increments (for example, to the left) and the cutting of the cutter blade 30 can be tested to determine if the pressure between the roller 40 and the blade 30 is sufficient for cutting the material (and that a clean cut is achieved).

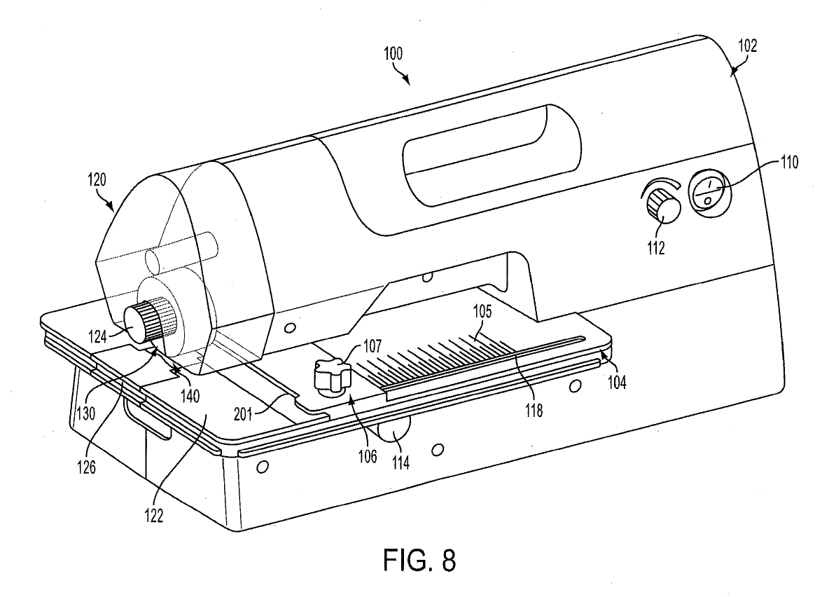

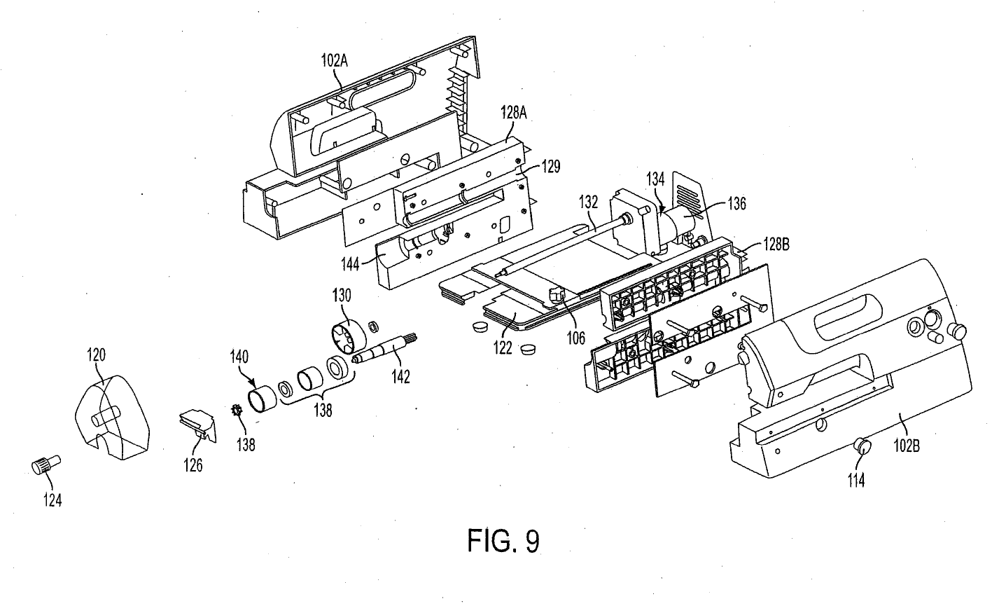

FIGS. 8 and 9 illustrate another embodiment of a rotary cutting device 100 in accordance with the present disclosure that includes a body comprising main housing 102, a base 104 attached thereto, and a material guide 106 movably disposed on base 104. The rotary cutting device 100 is configured such that material may be positioned on the base 104 and fed for cutting or embossing a material. More specifically, rotary cutting device 100 includes at least one cutter blade and an embossing roller 130 or disc which are interchangeable for mounting on a rotating shaft 132 in the housing 102. Thus, rotary cutting device 100 may be used to either cut or emboss a material being fed therethrough, depending on the mounted device. FIGS. 8-11 are shown with an embossing roller 130 mounted therein (further described below). Therefore, although reference is made in the description of this embodiment to the embossing roller 130, it is to be understood that the embossing roller 130 is interchangeable with as a cutter blade as well, and that such description also applies to cutter blade(s).

Main housing 102 is configured to house a drive mechanism 134, motor 136, and other components for supplying power to the rotary cutting device 100. Base 104 is used for positioning the device 100 on a surface (e.g., table) and for guiding material relative to the assembly for cutting or embossing.

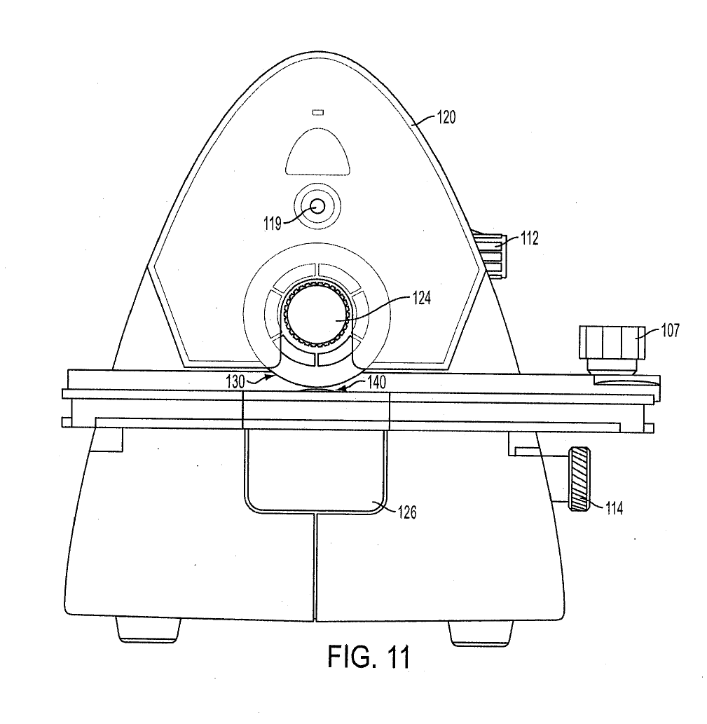

A guard 120 is removably attached to housing 102 by a fastener 119 (e.g., see FIG. 11), such as a screw. Fastener 119 is aligned and positioned through holes in the guard 120 and side of the housing 102 so that when fastener is tightened the guard 120 and housing 102 are attached to each other. The guard 120 acts a safety device that reduces and/or prevents direct access to a cutter blade or an embossing roller 130 by covering the mounted device. Removal of fastener 119 allows for removal of guard 120 and thus enables the user to access the mounted device, i.e., embossing roller 130. In an embodiment, a safety switch (not shown) is disposed within guard 120 so that if/when guard 120 is removed from housing 102, the switch is activated to prevent the motor from rotating shaft 142 and hence embossing roller 130. Housing 102 is open at a bottom end to enable a portion of embossing roller 130 to extend outwardly therefrom. Guard 120 can be made of a clear material, such as a molded plastic, to enable the user to see the embossing roller 30 (e.g., so that a type or edge of embossing roller 30 may be easily viewed).

Embossing roller 130 is roller or disc with an embossing edge around its periphery that is designed to emboss (e.g., press) a design onto or into a material using pressure, to raise or represent a design in relief, e.g., a raised ornamental design is provided on the material. Embossing roller 130 is configured to be positioned and rotated relative to a pressure roller 140 by mounting on a shaft 132 in the body. Embossing roller 130 includes an edge comprising a width that has a raised design thereon. Embossing roller 130 may be a molded device made of plastic, metal, or other material. Embossing roller 130 is mounted on housing 102 using a knob 124. Knob 124 holds embossing roller 130 in place and can be tightening or loosened by rotating the knob 124. Further details regarding mounting embossing roller 130 are described below.

As shown in FIG. 8, for example base 104 includes a plate portion 122. Material guide 106 is movably mounted on base 104 in communication with plate portion 122. Guide 106 is provided to guide material into the device for embossing (or cutting) relative to embossing roller 130 and to select a width or area at which material is embossed. Guide 106 is positioned so that a longitudinal edge 201 thereof is positioned relative to (e.g., adjacent to) embossing roller 30. Base 104 includes a slot 118 through which a guide knob 107 extends. Guide knob 107 may be tightened or loosened so that the guide 106 can be moved via knob 107 sliding within slot 118 and relative to base 104 so that longitudinal edge 201 of the guide 106 can be positioned (relative to the embossing roller) at the desired width. Knob 107 is tightened in a position within slot 118 at a desired location therealong. Indicia 105 is printed on plate portion 122 and/or base 104 to aid in positioning guide 106 for embossing or cutting the desired width of material strip as described above.

Roller tab 126 is removably disposed on plate portion 122. Roller tab 126 is mounted to base 104. A pressure roller 140 is located within base 104 (described below). Roller tab 126 includes an aperture or opening through which a portion of pressure roller 140 is configured to extend (upwardly) therethrough and to communicate with an edge of embossing roller 130.

FIG. 9 shows an exploded view of rotary cutting device 100 so that parts of the assembly can be readily viewed. The housing 102 comprises a first side 102A and a second side 102B that are connected together, and inner housing structures 128A and 128B for securing and mounting the devices therein. A pressure roller 140 and embossing roller 130 are arranged to be relatively spaced (with respect to each other) such that a length of material can be received therebetween for embossing. Embossing roller 130 is configured to be mounted on a shaft 132 using knob 124 (e.g., knob 124 locks embossing roller 130 onto shaft 132 so that the roller 130 will rotate with the shaft 132, not relative thereto). Shaft 132 is mounted in the housing 102 and is attached to drive mechanism 134. Inner housing 128A and 128B include a slot 129 for receiving shaft 132, such that shaft 132 is free to rotate within the housing. Drive mechanism 134 includes a motor 136, such as an electrically powered motor, and a plurality of gears (not shown). Drive mechanism 134 and motor 136 are located within main housing 102, and are configured to selectively receive power from a power source (e.g., via a plug device) and to rotate shaft 132 upon receipt of power (e.g., via a foot pedal). Drive mechanism 134 may have any number of motors and may include one or more transmissions (not shown). Motor 136 may be an AC induction motor or a DC motor. Motor 136 operates using electrical power to rotatably drive shaft 132 so that a mounted embossing roller 130 is rotated relative to pressure roller 140.

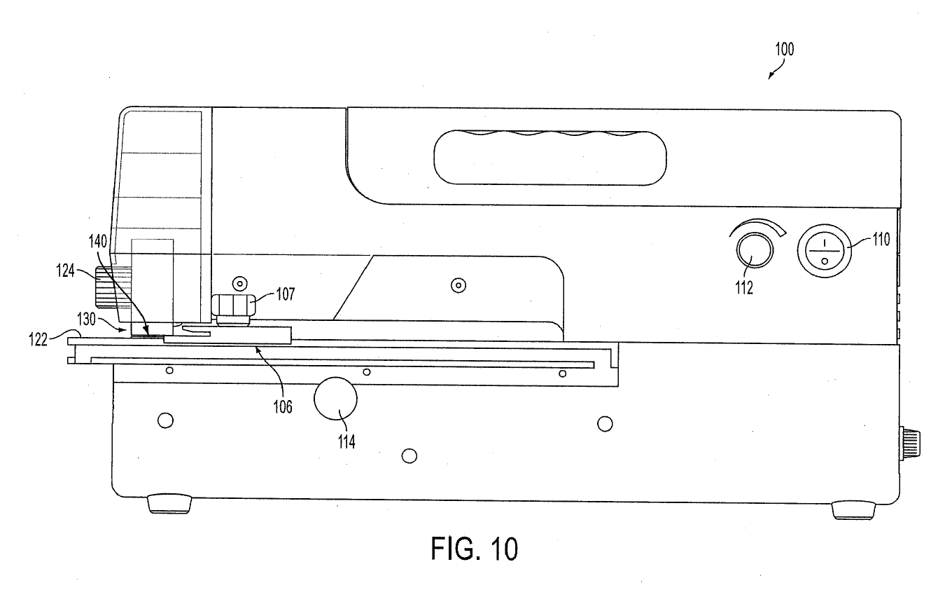

Pressure roller 140 is configured to provide pressure to material toward embossing roller 130 (i.e., in an upward direction) so that material is embossed as it is fed through the device 100. FIGS. 10 and 11 show how pressure roller 140 and embossing roller 130 are mounted in the housing 102 and relatively closely spaced to each other (and positioned to receive the length of material to be embossed). In an embodiment, pressure roller 140 is mounted to the device 100 and positioned relative to embossing roller 130 using a screw lock assembly, such as assembly 50, described above. In another embodiment, a pressure adjustment assembly comprises a bearing shaft 142 with a plurality bearings 138 disposed thereon. Pressure roller 140 is mounted on bearing shaft 142 with bearings 138. Bearing shaft 142 extends through housing 102 and is mounted therein. Bearing shaft 142 is movably disposed in aperture 144 of inner housing 128A and 128B (see FIG. 9). Specifically, bearing shaft 142 is configured to rotate about an axis. Like the embodiment shown in FIG. 6, bearing shaft 142 can include an end element, a middle portion, and an end, with the middle portion designed to receive pressure roller 140 thereon, and the pressure roller 140 being mounted such that it is fixed on the bearing shaft 142 and can rotate with the shaft 142, but does not rotate relative to the shaft 142. Pressure roller 140 is fixed to remain rotationally stationary relative to the bearing shaft 142 and to the embossing roller 130.

Pressure roller 140 is adapted to be moved vertically to adjust the distance between the embossing roller 130 and the roller as described above. In an embodiment, to move pressure roller 140, the device 100 is provided with an adjustment knob 114 that is mounted to housing 102 (e.g., on a side) to move the roller up and down. As noted above, pressure roller 140 is adapted to be adjusted relative to the embossing roller 130 (i.e., vertically in an upward or vertical direction, when the device 100 is positioned on a surface). When knob 114 is rotated (and thus pressure roller 40 is moved in an upward direction or downward direction in relation to embossing roller 130), the pressure to be applied to a material positioned between the pressure roller 40 and embossing roller 130 is also adjusted. In one embodiment, knob 114 can be turned in increments (e.g., in increments of ⅛ inches) so that a user can incrementally test the pressure for embossing the material. Knob 114 may be moved in a first direction (to the left, or counterclockwise) to move pressure roller 140 in an downwardly vertical direction relative to embossing roller 130, and a second direction (opposite, i.e., to the right, or clockwise) to move the roller 140 in an upwardly vertical direction relative to the embossing roller 130, or vice versa.

Of course, a separate tool (such as a screw driver, described in relation to device 10 above), can also be used with device 100.

In an embodiment, as a user rotates knob 114, a tactile, and possibly an audio (e.g., a clicking noise), feedback may be provided as the pressure roller 140 moves. Thus, the user will actually be able to feel and/or hear the plurality of predefined positions for positioning the pressure roller as the knob 114 is moved. This provides the user with a quick and easy way to incrementally change the spacing between the embossing roller 130 and pressure roller 140 surfaces, and thus the pressure applied to the material.

Rotary cutting device 100 may also comprise a speed control knob 112 that is operatively connected to the motor 136 for adjusting a speed at which the shaft 132 and thus the embossing roller 130 rotates relative to the pressure roller. The speed control knob 112 is configured to adjust an amount of voltage provided to motor 136, for example, using known devices (e.g., a potentiometer). When the speed control knob 112 is rotated, the amount of voltage delivered to the motor 136 is adjusted (either increased or decreased). This, in turn, adjusts a speed at which the shaft 132 and thus the embossing roller 130 rotates relative to the pressure roller 140. In the illustrated embodiment, the speed control knob 112 is shown mounted to a wall of the housing 102, adjacent to a power switch 110. In an embodiment, movement of knob 112 by the user may provide the user with a tactile, and possibly an audio (e.g., a clicking noise). Thus, the user will actually be able to feel and hear the plurality of predefined positions as the knob 112 is moved from one speed to another. This provides the user with a quick and easy way to incrementally change the rotational speed of the embossing roller 130.

The ranges of speeds for supplying rotational power via the knob 112 may include any number of speeds, including zero or no speed.

Power switch 110 allows the user to supply power to the shaft 32 of the device 100. Although not shown in FIGS. 1-6, rotary cutting device 10 may also include a power button. Power switch 110 may be a push button that, when pushed, is configured to power to the motor 136, which will then selectively be used to thereby rotate the shaft 132 and embossing roller 130 (or cutter blade). For example, in such an embodiment, even though a user may turn the power switch 110 to an “ON” position, the motor 136 would not rotate the embossing roller 130 until a foot pedal (not shown) is pressed. Generally, the construction and operation of the switch 110 and devices for controlling a motor are well known, and any construction for these may be used.

In an embodiment, the rotary cutting device 100 comes with an embossing roller and a cutter blade. As noted, a cutter blade such as cutter blade 30 (described with respect to FIGS. 1-7) may be used in rotary cutting device 100. In another embodiment, device 100 may be used with two or more embossing rollers that may be interchanged for one another. In yet another embodiment, a plurality of embossing rollers (of different designs) and a plurality of cutter blades (of different designs) may be mounted in the device 100 and used for embossing or cutting material.

In an embodiment, each device for mounting on shaft 132 can include a hole for alignment with a notch on the device for accurate installation, as described above with respect to device 10. Also, a variety of different edged cutter blades, such as those shown in FIGS. 7(A)-7(G), can be used with rotary cutter device 10, depending on the user's desired cut or edge finish. Moreover, the variety of embossing rollers that are used with device 100 may include similar designs as shown in FIGS. 7(A)-7(G). One or more second embossing rollers with different embossing edges may be provided with the device 100 or provided (e.g., sold) separately. For example, the embossing roller(s) may emboss a scallop design, a pinking design, a perforating design, a straight edge design, a smaller wave design, a larger wave design, or a deckle design onto a material.

The size of the cutter blades and/or embossing rollers used with rotary cutting device 100 is not meant to be limiting. In an embodiment, the embossing roller 130 has a size of approximately 40 mm to 50 mm, plus or minus a few mm. In another embodiment, the embossing roller has a size of approximately 45 mm, plus or minus one mm.

To remove or change the embossing roller 130 (with either another embossing roller or a cutter blade), the device 100 is positioned so that the mounted roller 130 and guard 120 are accessible. The fastening device 119 of guard 120 is unscrewed with a tool (e.g., screw driver) so that the guard 120 is unattached from the housing 102. The guard 20 is removed (e.g., sliding a direction away from housing 102) and set aside.

Knob 124 is rotated for loosening and removal from connection with shaft 132 (e.g., in a counterclockwise direction). This allows for removal of the mounted embossing roller 130. Once removed, knob 124 is set aside.

It should be appreciated that in order to remove the mounted embossing roller 130, the pressure between the roller 130 and pressure roller 140 may need to be loosened. Thus, the pressure roller 140 can be moved via turning the knob 114 (e.g., turning in a counterclockwise direction) to move the pressure roller 40 in an opposite direction relative to (i.e., away from) the mounted embossing roller 130. The roller 130 is then removed from the shaft 132 and device 100.

Assuming the embossing roller 130 (or cutter blade) for mounting has a two holes as noted above (i.e., a first (larger) hole and a second (smaller) hole for mounting on shaft and aligning with a notch, respectively), the substitute embossing roller 130 (or cutter blade) is positioned and aligned on the device 100 so that the second (smaller) hole aligns with the notch. The guard 120 may then be aligned relative to the housing 102 and mounted in place by tightening fastening device 119 in place. The pressure roller 140 may also be moved (tightened). The rotary cutting device 100 is then ready for use with the newly mounted embossing roller 130 (or cutter blade).

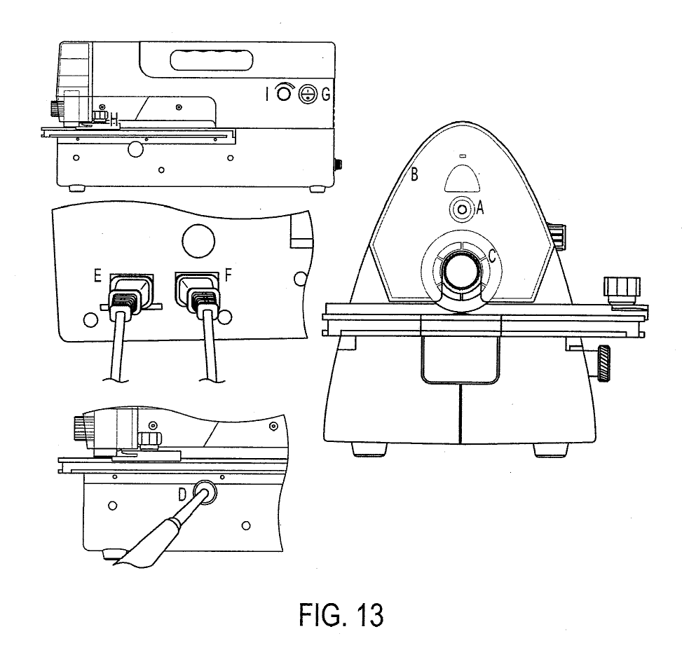

Once the proper roller/blade has been installed and the user is ready to use the device 100, the device can be plugged into a polarized electrical outlet or wall socket. Although not shown, the device 100 is provided with an electric supply cord and polarized plug configured for insertion into such an outlet, to receive power thereto. For example, the device may be designed for universal electronic sources and be UL approved for the United States and Australia. The plug and its cord may be attached directly to, or removably attached to, the device (e.g., attached to or inserted into an area on the back of the machine) (see, e.g., FIG. 13). For example, the cord may have a connection device at one end for connection to the device and a plug at its other end for connection to the outlet. In an embodiment, a foot pedal (also not shown) attaches to the device. The foot pedal may be configured to connect to the device via an electrical cord at one end, with the other end connection to an electrical outlet, so that power can be delivered to the rotary cutting device via pressure applied to the foot pedal. A foot pedal allows a user to selectively enable the operation of the rotary cutting device 100. The user presses the foot pedal to drive motor 136 and rotate embossing roller 130 (or blade).

In an embodiment, it is envisioned that the rotary cutting device may receive power from batteries supplied in a battery compartment (not shown). The battery compartment may be provided as an alternative to or in addition to an electrical cord with a plug.

To use the rotary cutter device 100, a user first determines a width of a strip of material to be cut. The longitudinal edge 201 of the guide 106 is adjusted by rotating the knob 107 (e.g., loosening in a counterclockwise direction) and sliding the guide 106 within slot 118. Once the longitudinal edge of the guide 106 is provided at a desired width (e.g., by aligning with a selected length as indicated by indicia 105), knob 107 is tightened to secure guide 106 (e.g., in an opposite direction for loosening, e.g., in a clockwise direction).

Then, an edge of material is positioned against longitudinal edge 201 of the guide. 106, and the foot pedal is pressed to supply power to the device 100 and to begin embossing (e.g., by guiding and pulling material along the guide 106).

If the user determines that the embossing roller 130 does not emboss the material as desired, the user can adjust the pressure between the roller 130 and the pressure roller 140. Pressure to the foot pedal (not shown) is released, and the power to the device 100 turned off. Knob 114 can be turned in increments (for example, to the left) and the pressure of the embossing roller 130 can be tested to determine if the pressure between the roller 140 and the roller 130 is sufficient for pressing the design, i.e., embossing, the material.

During use of the rotary cutting device 100, the user can adjust the speed control knob 112 to decrease or increase the embossing speed (i.e., the rotation of the embossing roller 130).

The rotary cutter devices 10 and 100 each provide an automatic, powered machine configured to cut and/or emboss materials more quickly and efficiently (e.g., as compared to manual hand cutters or cranks). It allows for different types or patterns of cutter blades and/or embossing rollers to be quickly interchanged and used for cutting/embossing materials. Additionally, rotary cutter device 100 allows for easily alteration between cutting and embossing. A speed control device (such as shown and described in the rotary cutter device 100 of FIGS. 8-11) also allows for rotational speed control of the cutter blade 30, so that different types of materials can be cut with a reduced risk of the material drifting or pulling during cutting.

Both embodiments of the rotary cutter 10 and 100 include several safeguards to ensure safety and prevent and/or reduce injury to the user. As noted, edges of the blades themselves are not sharp and can be held in a user's hand without risk of injury. Also, cutter guard 20 is provided to prevent direct access to the blade mounted in the machine. As described, in order to change a blade (or embossing roller), the cutter guard 20 is removed. Conversely, if the cutter guard 20 is not installed (correctly), the rotary cutter device 10 or 100 will not cut/emboss. Switch 54 is designed to prevent rotation of the shaft 32 (and hence, the mounted cutter blade 30), when the cutter guard 20 is detached from the cutter housing 18. Turning power off to the machine manually (e.g., using power switch 110 or unplugging) and/or using switch 54 aids in preventing accidental injury to the user. Also, if the blade or embossing roller is misaligned during installation, it will not be rotated by shaft 32.

The construction and configuration of rotary cutting device 10 and 100 are shown as examples and not intended to be limiting. Any parts of the device 10 may be made of plastic, metal, other materials, or any combination thereof. The parts of the device 10 may optionally be made from molded plastic. Also, each of the features described herein may be formed separately or integrally with the structures they are associated with. Devices such as fasteners, screws, or bolts, nuts, glue or adhesive, or other attachment and/or fastening devices may be used to secure parts (e.g., motor housing 12 and cutter housing 18) together, if needed. Additionally and/or alternatively, shock absorbing elements, vibration absorbing elements, and/or springs may be used, in rotary cutting device 10.

While the principles of the disclosure have been made clear in the illustrative embodiments set forth above, it will be apparent to those skilled in the art that various modifications may be made to the structure, arrangement, proportion, elements, materials, and components used in the practice of the disclosure. For example, it is to be understood that indicia such as directional arrows may be provided on the housing of the rotary cutting devices, e.g., to indicate which direction moves the pressure roller up and which moves the pressure roller down. Also, the features described with respect to rotary cutting device 10 and device 100 are not meant to be exclusive. That is, features described with respect to one device may be utilized and/or substituted for another in the other device. For example, in an embodiment, rotary cutting device 10 may be provided with a speed control knob 112 operatively connected to the motor 36 for adjusting rotational speed of the shaft 32/cutter blade 30 relative to the pressure roller 40 and thus the speed at which the material being fed is cut between the cutter blade 30 and the pressure roller 40.

It will be appreciated that variations of the above-disclosed and other features and functions, or alternatives thereof, may be desirably combined into many other different systems/devices or applications. Various presently unforeseen or unanticipated alternatives, modifications, variations, or improvements therein may be subsequently made by those skilled in the art which are also intended to be encompassed by the following claims.

What is claimed is:

1. A rotary cutting device comprising:
a body comprising a motor therein that is configured to selectively receive power from a power source;
a cutter blade with a cutting edge mounted to a shaft in the body, the shaft configured to rotate about a rotational axis; and
a pressure roller mounted relative to the cutter blade on a bearing shaft, the pressure roller being fixed to remain rotationally stationary relative to the bearing shaft and to the cutter blade,
the cutter blade and the pressure roller being positioned relative to each other such that pressure is applied to a material fed therebetween,
wherein the motor is configured to selectively rotate the shaft about its axis upon receipt of power from the power source such that the cutter blade rotates relative to the pressure roller so that a width of material is cut by the cutting edge as the material is fed between the rotating cutter blade and the pressure roller.

2. The rotary cutting device according to claim 1, further comprising a guide on the body for guiding material into the rotary cutting device, the guide configured to be used to select the width at which material is cut.

3. The rotary cutting device according to claim 1, wherein the pressure roller is further configured to rotate with the bearing shaft about an axis, and wherein rotation of the bearing shaft and pressure roller about the axis is configured to move a position of the pressure roller relative to the cutter blade so that the pressure applied to the material fed between the cutter blade and the pressure roller is adjusted.

4. The rotary cutting device according to claim 1, further comprising a speed control knob operatively connected to the motor for adjusting a speed at which the shaft rotates in order to adjust a speed at which the cutter blade rotates relative to the pressure roller and cuts the material being fed between the cutter blade and the pressure roller.

5. The rotary cutting device according to claim 1, further comprising at least a second cutter blade with a different cutting edge, and wherein the at least second cutter blade is configured to be provided on the shaft for rotation in place of the cutter blade, such that the material being fed into the rotary cutting device is cut using the different cutting edge of the at least second cutter blade.

6. The rotary cutting device according to claim 1, further comprising at least one embossing roller with an embossing edge, and wherein the at least one embossing roller is configured to be provided on the shaft for rotation in place of the cutter blade, such that the material being fed into the rotary cutting device is embossed when it is fed between the at least one embossing roller and the pressure roller.

7. A rotary cutting device comprising:
a body comprising a motor therein that is configured to selectively receive power from a power source;
an embossing roller with an embossing edge mounted to a shaft in the body, the shaft configured to rotate about a rotational axis;
a pressure roller mounted relative to the embossing roller on a bearing shaft, the pressure roller being fixed to remain rotationally stationary relative to the bearing shaft and to the embossing roller;
the embossing roller and the pressure roller being positioned relative to each other such that pressure is applied to a material fed therebetween,
wherein the motor is configured to selectively rotate the shaft about its axis upon receipt of power from the power source such that the embossing roller rotates relative to the pressure roller so that a width of material is embossed using the embossing edge as the material is fed between the rotating embossing roller and the pressure roller.

8. The rotary cutting device according to claim 1, further comprising a guide on the body for guiding material into the rotary cutting device, the guide configured to be used to select the width at which material is embossed.

10. The rotary cutting device according to claim 1, wherein the pressure roller is further configured to rotate with the bearing shaft about an axis, and wherein rotation of the bearing shaft and pressure roller about the axis is configured to move a position of the pressure roller relative to the embossing roller so that the pressure applied to the material fed between the embossing roller and the pressure roller is adjusted.

11. The rotary cutting device according to claim 1, further comprising a speed control knob operatively connected to the motor for adjusting a speed at which the shaft rotates in order to adjust a speed at which the embossing roller rotates relative to the pressure roller and embosses the material being fed between the embossing roller and the pressure roller.

12. The rotary cutting device according to claim 1, further comprising at least a cutter blade with a cutting edge, and wherein the at least cutter blade is configured to be provided on the shaft for rotation in place of the embossing roller, such that the material being fed into the rotary cutting device is cut using the cutting edge of the cutter blade.

13. The rotary cutting device according to claim 1, further comprising at least a second embossing roller with a second embossing edge, and wherein the at least second embossing roller is configured to be provided on the shaft for rotation in place of the embossing roller, such that the material being fed into the rotary cutting device is embossed using the second embossing edge when it is fed between the at least second embossing roller and the pressure roller.

14. A method for cutting material using a rotary cutting device comprising a body comprising a motor therein that is configured to selectively receive power from a power source, a cutter blade with a cutting edge mounted to a shaft in the body, the shaft configured to rotate about a rotational axis, a pressure roller mounted relative to the cutter blade on a bearing shaft, the pressure roller being fixed to remain rotationally stationary relative to the bearing shaft and to the cutter blade, the cutter blade and the pressure roller being positioned relative to each other such that pressure is applied to a material fed therebetween, and the motor being configured to selectively rotate the shaft about its axis such that the cutter blade rotates relative to the pressure roller so that a width of material is cut by the cutting edge as the material is fed between the rotating cutter blade and the pressure roller; the method comprising:
providing the rotary cutting device;
providing power to the motor from the power source;
rotating the shaft about its axis so that the cutter blade rotates relative to the pressure roller;
inserting the material into the machine and between the cutter blade and the pressure roller, and
cutting the material using pressure from the cutter blade and the pressure roller.

15. The method according to claim 14, wherein the rotary cutting device further comprises a guide on the body for guiding material into the rotary cutting device, the guide configured to be used to select the width at which material is cut, and wherein the method further comprises guiding the material along the guide to cut the materials at a selected width.

16. The method according to claim 14, wherein the pressure roller is configured to rotate with the bearing shaft about an axis, the rotation of the bearing shaft and pressure roller about the axis being configured to move a position of the pressure roller relative to the cutter blade, and wherein the method further comprises rotating the bearing shaft about its axis, and adjusting the positioning of the pressure roller relative to the cutter blade so that the pressure applied to the material fed between the cutter blade and the pressure roller is adjusted.

17. The method according to claim 14, wherein the rotary cutting device further comprises a speed control knob operatively connected to the motor for adjusting a speed at which the shaft rotates, and wherein the method further comprises rotating the speed control knob to adjust a speed at which the cutter blade rotates relative to the pressure roller and cuts the material being fed between the cutter blade and the pressure roller.

18. The method according to claim 14, wherein the rotary cutting device further comprises at least a second cutter blade with a different cutting edge and/or at least one embossing roller with an embossing edge, the at least second cutter blade and the at least one embossing roller each configured to be provided on the shaft for rotation in place of the cutter blade, and wherein the method further comprises:
removing the cutter blade from the shaft,
selecting one of the at least second cutter blade or the at least one embossing roller, and
mounting the selected one of the at least second cutter blade or the at least one embossing roller on the shaft, such that the material being fed into the rotary cutting device is manipulated using the selected one when it is fed between the at least second cutter blade or the at least one embossing roller and the pressure roller.
